(19) United States
(12) Patent Application Publication
(10) Pub. No.: US 2025/0310746 A1
(43) Pub. Date: Oct. 2, 2025

(54) NODE IDENTIFICATION USING SIDELINK IN A WIRELESS COMMUNICATIONS NETWORK

(71) Applicant: Lenovo (Singapore) Pte. Limited, Singapore (SG)

(72) Inventors: Prateek Basu Mallick, Dreieich (DE); Joachim Löhr, Wiesbaden (DE); Dimitrios Karampatsis, Ruislip (GB); Karthikeyan Ganesan, Nauheim (DE)

(73) Assignee: Lenovo (Singapore) Pte. Limited, Singapore (SG)

(21) Appl. No.: 19/109,700

(22) PCT Filed: Nov. 18, 2022
(86) PCT No.: PCT/EP2022/082458

§ 371 Date: Mar. 7, 2025

(30) Foreign Application Priority Data
Sep. 27, 2022 (GR) 20220100791

(51) Int. Cl. H04W 8/00; H04W 76/20; H04W 92/18

(52) U.S. Cl. CPC H04W 8/005; H04W 76/20; H04W 92/18

(57) ABSTRACT

Accordingly, there is provided a method in a sidelink remote user equipment, the method comprises receiving a discovery message including a cell identity and a length field from a sidelink relay user equipment. The method further comprises receiving a system information message from a serving cell of a serving node. The method further comprises determining a node identity from the received discovery message; and determining if the node identity determined from the received discovery message is the same as that included in the system information message.

### FIELD

The subject matter disclosed herein relates generally to the field of implementing node identification using sidelink in a wireless communications network. This document defines a method in a sidelink remote user equipment, a sidelink remote user equipment, a method in a sidelink relay user equipment, and a sidelink relay user equipment.

### BACKGROUND

3GPP RAN approved a study item “Study on NR Sidelink Relay” in Rel-17 to cover the enhancements and solutions necessary to support the UE-to-network Relay and UE-to-UE Relay coverage extension, considering wider range of services including V2X, Public Safety and commercial applications and services. The study outcome was documented in 3GPP TR 38.836 v17.0.0, which describes potential technical solutions for the sidelink relay with a conclusion that both Layer-2 based Relay architecture and Layer-3 based Relay architecture are feasible. However, the presently documented technical solutions include only limited features. In particular, only UE-to-Network relay is supported and the service continuity solution is limited to intra-gNB direct-to-indirect and indirect-to-direct path switching in the Layer-2 relay.

Proximity Services (ProSe) were first introduced in Release 12 of the 3GPP specifications. This is a D2D (Device-to-Device) technology that allows LTE and 5G devices to detect each other and to communicate directly. In comparison to existing D2D and proximity networking technologies, ProSe offers a number of distinct benefits including better scalability, manageability, privacy, security and battery-efficiency.

For better support of use cases requiring sidelink relay, further enhancements are necessary. For example, support of UE-to-UE relay is essential for the sidelink coverage extension without relying on the use of uplink and downlink. Service continuity enhancements in UE-to-Network relay are also necessary to cover all potential mobility scenarios.

Typically, a sidelink connection comprises a remote UE connecting to the wireless communication network via a relay UE. Some, or all, communications between the remote UE and the wireless communication network are relayed via the relay UE. The remote UE may use multi-path communication whereby only some communications between the remote UE and the wireless communication network are relayed via the relay UE. Other communications may be relayed by another relay UE, or may be transmitted directly between the remote UE and the wireless communication network.

### SUMMARY

A problem with sidelink communications is that a sidelink remote UE is unable to use multi-path diversity when the sidelink and a direct link terminate at different base stations of the wireless communication network. Multi-path diversity, where a remote UE is connected to a network via direct and indirect paths, has a potential to improve the reliability/robustness as well as throughput. A multi-path relay solution can also be utilized for UE aggregation where a UE is connected to the network via a direct path and also via another UE using a non-standardized UE-UE interconnection. UE aggregation aims to provide network connectivity to applications requiring high UL bitrates on 5G terminals in cases when normal UE-NodeB connections are too limited by UL UE transmission power to achieve required bitrate.

Disclosed herein are procedures for node identification using sidelink in a wireless communications network. Said procedures may be implemented by a method in a sidelink remote user equipment, a sidelink remote user equipment, a method in a sidelink relay user equipment, and a sidelink relay user equipment.

There is provided a method in a sidelink remote user equipment, the method comprises receiving a discovery message including a cell identity and a length field from a sidelink relay user equipment. The method further comprises receiving a system information message from a serving cell of a serving node. The method further comprises determining a node identity from the received discovery message; and determining if the node identity determined from the received discovery message is the same as that included in the system information message.

There is further provided a sidelink remote User Equipment (UE) comprising a receiver and a processor. The receiver is arranged to receive a discovery message including a cell identity and a length field from a sidelink relay user equipment. The receiver is further arranged to receive a system information message from a serving cell of a serving node. The processor is arranged to determine a node identity from the received discovery message. The processor is further arranged to determine if the node identity determined from the received discovery message is the same as that included in the system information message.

A sidelink remote UE may thus identify if a serving cell and a sidelink relay UE are terminated in (or belonging to) the same serving node. If they are, then the sidelink remote UE is able to use multi-path diversity. The method allows a sidelink remote UE to keep searching for a sidelink relay user equipment that will provide it with multi-path diversity, thus improving the connection between the sidelink remote UE and the overall operation of the wireless communication network.

The discovery message may be received before the system information message. Alternatively, the system information message may be received before the discovery message.

There is further provided a method in a sidelink relay User Equipment (UE), the method comprising: transmitting a discovery message including a cell identity and a LENGTH field to a sidelink remote user equipment; and receiving a connection request from the sidelink remote user equipment.

There is further provided a sidelink relay User Equipment (UE) comprising: a transmitter arranged to transmit a discovery message including a cell identity and a LENGTH field to a sidelink remote user equipment; and a receiver arranged to receive a connection request from the sidelink remote user equipment.

There is further provided a method in a Radio Network node, the method comprising: transmitting system information message; receiving an RRC Setup Request from a User Equipment; and transmitting an RRC Setup Complete to the User Equipment.

There is further provided a Radio Network node comprising a transmitter and a receiver. The transmitter is arranged to transmit a system information message. The receiver is arranged to receive an RRC Setup Request from a User Equipment. The transmitter is arranged to transmit an RRC Setup Complete to the User Equipment.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for node identification using sidelink in a wireless communications network will now be described, by way of example only, with reference to the accompanying drawings, in which:

FIG. 1 depicts an embodiment of a wireless communication system for node identification using sidelink in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a sidelink remote user equipment;

FIG. 5 illustrates a method in a sidelink relay user equipment;

FIG. 6 illustrates a method in a Radio Network node;

FIG. 7 illustrates a wireless communication system;

FIG. 8 illustrates the composition of a NR Cell Global Identity;

FIG. 9 illustrates a procedure for 5G ProSe Direct Discovery with Model A, using a single discovery protocol message (‘Announcement’); and

FIG. 10 illustrates a procedure for 5G ProSe Direct Discovery with Model B, using two discovery protocol messages (‘Solicitation and Response’).

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in the Figures, where appropriate.

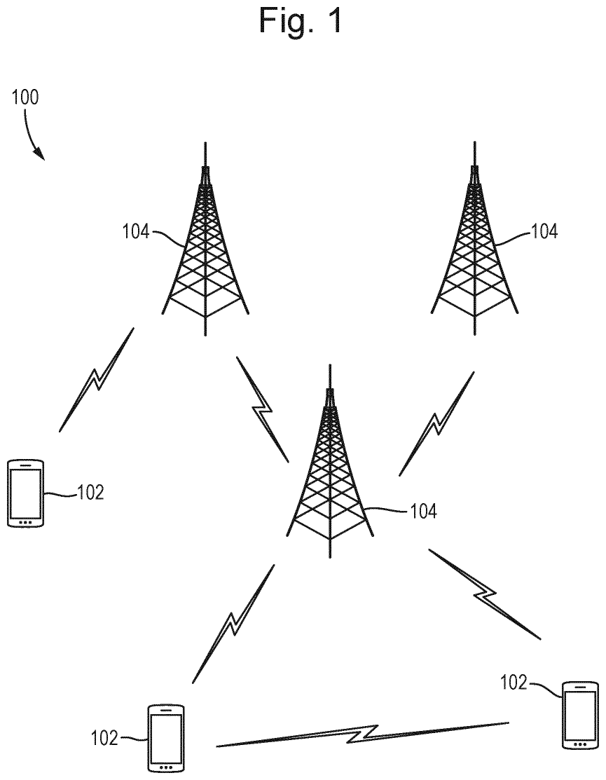

FIG. 1 depicts an embodiment of a wireless communication system 100 for node identification using sidelink in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

3GPP RAN approved a study item “Study on NR Sidelink Relay” in Rel-17 to cover the enhancements and solutions necessary to support the UE-to-network Relay and UE-to-UE Relay coverage extension, considering wider range of including V2X, Public Safety and commercial applications and services. The study outcome was documented in 3GPP TR 38.836 v17.0.0, which documents potential technical solutions for the sidelink relay with a conclusion that both Layer-2 based Relay architecture and Layer-3 based Relay architecture are feasible. However, the presently documented technical solutions include only limited features due to the lack of time. In particular, only UE-to-Network relay is supported and the service continuity solution is limited to intra-gNB direct-to-indirect and indirect-to-direct path switching in the Layer-2 relay.

Proximity Services (ProSe) were first introduced in Release 12 of the 3GPP specifications. This is a D2D (Device-to-Device) technology that allows LTE and 5G devices to detect each other and to communicate directly. In comparison to existing D2D and proximity networking technologies, ProSe offers a number of distinct benefits including better scalability, manageability, privacy, security and battery-efficiency.

For better support of use cases requiring sidelink relay, further enhancements are necessary. For example, support of UE-to-UE relay is essential for the sidelink coverage extension without relying on the use of uplink and downlink. Service continuity enhancements in UE-to-Network relay are also necessary to cover all potential mobility scenarios.

In addition, support of multi-path with relay, where a remote UE is connected to a network via direct and indirect paths, has a potential to improve the reliability/robustness as well as throughput. A multi-path relay solution can also be utilized for UE aggregation where a UE is connected to the network via a direct path and also via another UE using a non-standardized UE-UE interconnection. UE aggregation aims to provide network connectivity to applications requiring high UL bitrates on 5G terminals in cases when normal UE-NodeB connections are too limited by UL UE transmission power to achieve required bitrate. Such a situation is likely when the UE is located at an edge of a cell coverage area. Additionally, UE aggregation can improve connection reliability, stability and may reduce delay of services as well. That is, if the channel condition of a terminal is deteriorating, another terminal can be used to make up for the traffic performance unsteadiness caused by channel condition variation. In 5G, NR Cell Global Identifier (NCGI) is used to identify NR cells globally and similar to ECGI (EUTRA Cell Global Identifier) in 4G LTE. The NCGI is constructed from the PLMN ID the cell belongs to and the NR Cell Identity (NCI) of the cell.

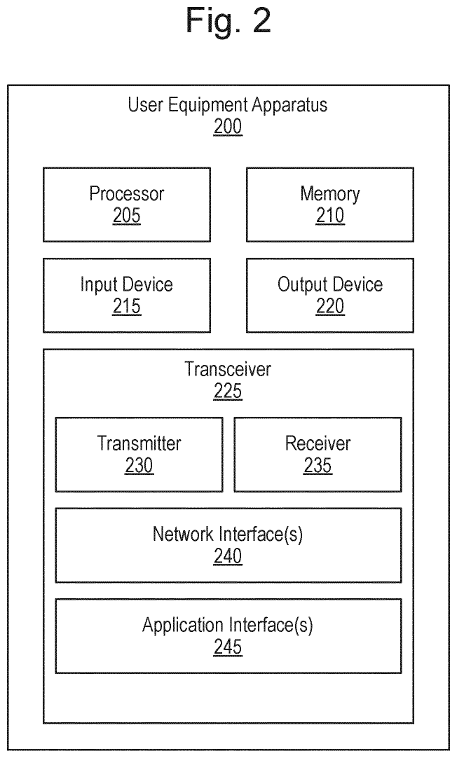

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a sidelink remote user equipment, a sidelink relay user equipment, a remote UE 730, a relay UE 740, or a UE 901 to 905 and 1001 to 1005, as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

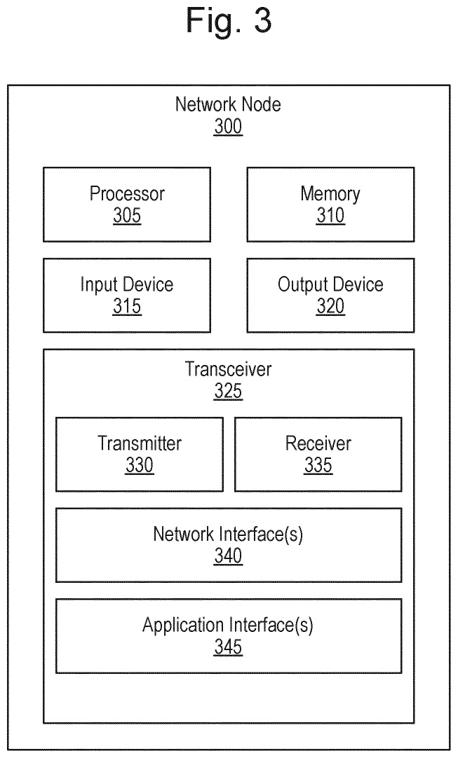

FIG. 3 depicts further details of the network node 300 that may be used for implementing the methods described herein. By way of example, the network node 300 may comprise a base unit 104, or a gNB-A 710 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

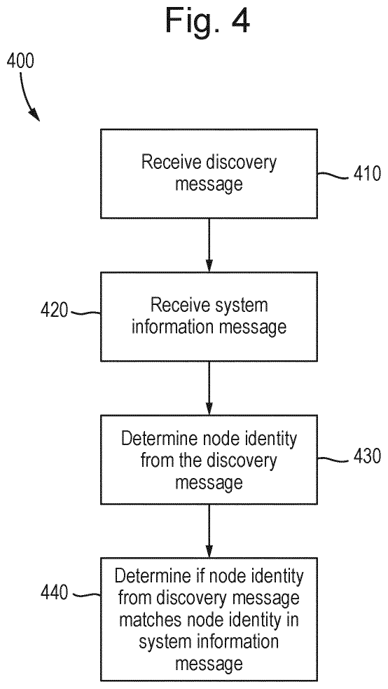

FIG. 4 illustrates a method 400 in a sidelink remote user equipment, the method 400 comprises receiving 410 a discovery message including a cell identity and a length field from a sidelink relay user equipment. The method 400 further comprises receiving 420 a system information message from a serving cell of a serving node. The method 400 further comprises determining 430 a node identity from the received discovery message; and determining 440 if the node identity determined from the received discovery message is the same as that included in the system information message.

The discovery message may comprise a 5G ProSe Direct Discovery message. The cell identity may comprise a cell identity. The system information message may comprise a System Information Block 1 message. The node identity may be a RAN (radio access network) node identity. The serving node may be a serving RAN node. The serving node may be a node in a wireless communication network. The serving node may be a gNB. The node identity may be the identity of the serving RAN node.

A sidelink remote UE may thus identify if a serving cell and a sidelink relay UE are terminated in (or belonging to) the same serving node. If they are, then the sidelink remote UE is able to use multi-path diversity. The method allows a sidelink remote UE to keep searching for a sidelink relay user equipment that will provide it with multi-path diversity, thus improving the connection between the sidelink remote UE and the overall operation of the wireless communication network.

The discovery message may be received before the system information message. Alternatively, the system information message may be received before the discovery message.

The method may further comprise selecting the sidelink relay user equipment to provide indirect connectivity towards the serving node if the node identity determined from the received discovery message is the same as that included in the system information message.

The method may further comprise looking for a further sidelink relay user equipment to provide indirect connectivity towards the serving node if the node identity determined from the received discovery message is not the same as that included in the system information message.

Looking for a further sidelink relay user equipment may comprise performing a discovery procedure. The discovery procedure may comprise a 5G ProSe Direct Discovery procedure. The method of claim 1 may comprise a first discovery procedure.

Looking for a further sidelink relay user equipment may comprise a second discovery procedure. The second discovery procedure may also be a 5G ProSe Direct Discovery procedure.

The sidelink remote user equipment may have a RRC Connection with the serving node. The node identity is included inside a 36 bits long cell identity and is determined as the leftmost LENGTH bits of the cell identity IE included in discovery message from a sidelink relay user equipment.

There is further provided a sidelink remote User Equipment (UE) comprising a receiver and a processor. The receiver is arranged to receive a discovery message including a cell identity and a length field from a sidelink relay user equipment. The receiver is further arranged to receive a system information message from a serving cell of a serving node. The processor is arranged to determine a node identity from the received discovery message. The processor is further arranged to determine if the node identity determined from the received discovery message is the same as that included in the system information message.

The discovery message may comprise a 5G ProSe Direct Discovery message. The cell identity may comprise a cell identity. The system information message may comprise a System Information Block 1 message. The node identity may be a RAN (radio access network) node identity. The serving node may be a serving RAN node. The serving node may be a node in a wireless communication network. The serving node may be a gNB. The node identity may be the identity of the serving RAN node.

A sidelink remote UE may thus identify if a serving cell and a sidelink relay UE are terminated in (or belonging to) the same serving node. If they are, then the sidelink remote UE is able to use multi-path diversity. The method allows a sidelink remote UE to keep searching for a sidelink relay user equipment that will provide it with multi-path diversity, thus improving the connection between the sidelink remote UE and the overall operation of the wireless communication network.

The receiver may be further arranged to receive the discovery message before the system information message. Alternatively, the receiver may be arranged to receive the system information message before the discovery message.

The processor may be further arranged to select the sidelink relay user equipment to provide indirect connectivity towards the serving node if the node identity determined from the received discovery message is the same as that included in the system information message.

The processor may be further arranged to look for a further sidelink relay user equipment to provide indirect connectivity towards the serving node if the node identity determined from the received discovery message is not the same as that included in the system information message. Looking for a further sidelink relay user equipment may comprise performing a discovery procedure.

The discovery procedure may comprise a 5G ProSe Direct Discovery procedure. The method of claim 1 may comprise a first discovery procedure. Looking for a further sidelink relay user equipment may comprise a second discovery procedure. The second discovery procedure may also be a 5G ProSe Direct Discovery procedure.

The sidelink remote user equipment may have a RRC Connection with the serving node. The node identity may be included inside a 36 bit long cell identity and may be determined as the leftmost LENGTH bits of the cell identity IE included in discovery message from a sidelink relay user equipment.

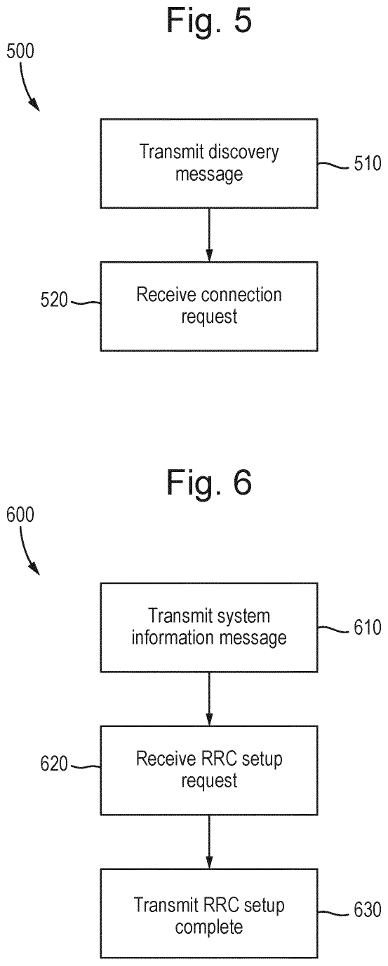

FIG. 5 illustrates a method 500 in a sidelink relay User Equipment (UE), the method comprising: transmitting 510 a discovery message including a cell identity and a LENGTH field to a sidelink remote user equipment; and receiving 520 a connection request from the sidelink remote user equipment.

The connection request may be received in response to the transmitted discovery message. The connection request may comprise a PC5 RRC Connection Request. A sidelink relay UE may thus allow a sidelink remote UE to identify if a serving cell and the sidelink relay UE are terminated in (or belonging to) the same serving node. If they are, then the sidelink remote UE is able to use multi-path diversity. The method allows a sidelink remote UE to keep searching for a sidelink relay user equipment that will provide it with multi-path diversity, thus improving the connection between the sidelink remote UE and the overall operation of the wireless communication network.

There is further provided a sidelink relay User Equipment (UE) comprising: a transmitter arranged to transmit a discovery message including a cell identity and a LENGTH field to a sidelink remote user equipment; and a receiver arranged to receive a connection request from the sidelink remote user equipment.

FIG. 6 illustrates a method 600 in a Radio Network node, the method 600 comprising: transmitting 610 system information message; receiving 620 an RRC Setup Request from a User Equipment; and transmitting 630 an RRC Setup Complete to the User Equipment.

There is further provided a Radio Network node comprising a transmitter and a receiver. The transmitter is arranged to transmit a system information message. The receiver is arranged to receive an RRC Setup Request from a User Equipment. The transmitter is arranged to transmit an RRC Setup Complete to the User Equipment.

A cell deployment scenario for multi-path relaying in Rel-18 may comprise any of:
Scenario C1: The relay UE and remote UE are served by a same cell;
Scenario C2: The relay UE and remote UE are served by different intra-frequency cells of a same gNB;
Scenario C3: The relay UE and remote UE are served by different inter-frequency cells of a same gNB.
Support may be provided for the following sidelink scenarios for multi-path:
Scenario S1: SL TX/RX and Uu share the same carrier at the remote UE;
Scenario S2: SL TX/RX and Uu use different carriers at the remote UE;
Scenario S3: SL TX/RX and Uu share the same carrier at the relay UE;
Scenario S4: SL TX/RX and Uu use different carriers at the relay UE.

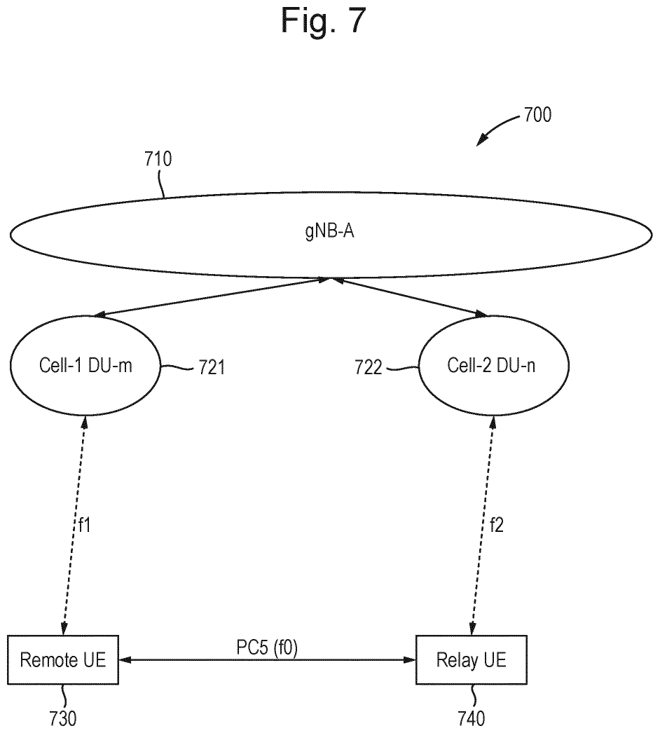

FIG. 7 illustrates a wireless communication system 700 comprising a sidelink connection. The wireless communication system 700 comprises a node B, in this case gNB-A 710, a first cell Cell-1 DU-m 721, a second cell Cell-2 DU-n 722, a remote UE 730 and a relay UE 740. Remote UE 730 communicates directly with gNB-A 710 via cell-1 DU-m 721. Remote UE 730 also communicates with gNB-A 710 using a sidelink via relay UE 740 which connects to gNB-A 710 via cell-2 DU-n 722.

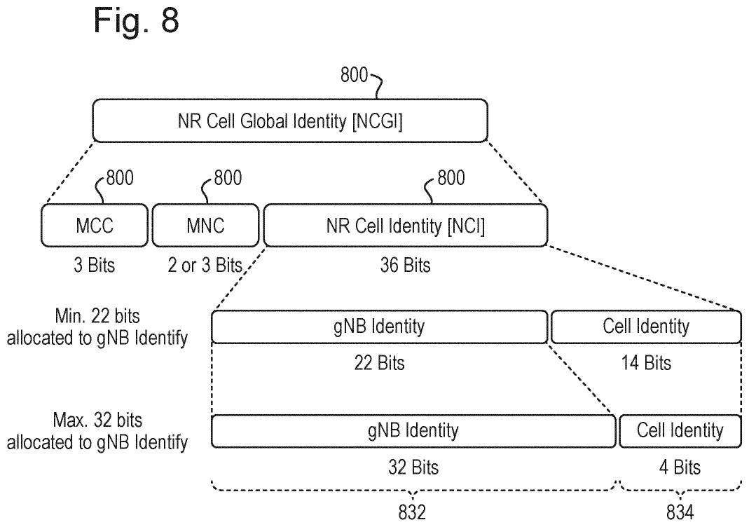

Release 18 of the 3GPP standard required that the remote UE 730 and the relay UE 740 could only be connected to the same gNB-A 710. Release 17 required that a Relay UE broadcasts NR Cell Global Identifier (NCGI, also called NR CGI) which is a field containing PLMN Id and a bitstring of size 36 bits, called cell Identity, or NR Cell Identity (NCI). FIG. 8, described below, illustrates the composition of a NR Cell Global Identity. The remote UE and relay UE extract the gNB Identity from this field. The 3GPP standards do not explain how to ensure that the remote UE and relay UE connect to the same gNB.

3GPP 38.413 v 17.2.0 defines the Global gNB ID. This Information Element is used to globally identify a gNB (see also 3GPP TS 38.300 v17.2.0). The definition of Global gNB ID as it appears in the 3GPP standard documents is given in Table 1, below.

TABLE 1
A definition of Global gNB ID information element.

| | | | | |
|---|---|---|---|---|
| IE/Group | | | IE type and | Semantics |
| Name | Presence | Range | reference | description |

| | | | |
|---|---|---|---|
| PLMN Identity | M | 9.3.3.5 | |
| CHOICE gNB ID | M | | |
| >gNB ID | | | |
| >>gNB ID | M | BIT STRING | Equal to the |
| | | (SIZE(22 . . . 32)) | leftmost bits |
| | | | of the NR |
| | | | Cell Identity |
| | | | IE contained |
| | | | in the |
| | | | NR CGI |
| | | | IE of each |
| | | | cell served |
| | | | by the gNB. |

Similarly, 3GPP TS 38.300 v17.2.0 defines that NR CGI Information Element that is used to globally identify an NR cell. The definition of Global NR CGI as it appears in the 3GPP standard documents is given in Table 2, below.

TABLE 2
A definition of Global NR CGI information element

| | | | | |
|---|---|---|---|---|
| IE/Group | | | IE type and | Semantics |
| Name | Presence | Range | reference | description |

| | | | |
|---|---|---|---|
| PLMN Identity | M | 9.3.3.5 | |
| NR Cell Identity | M | BIT STRING | The leftmost |
| | | (SIZE(36)) | bits of the |
| | | | NR Cell |
| | | | Identity IE |
| | | | correspond to |
| | | | the gNB ID |
| | | | (defined in |
| | | | subclause |
| | | | 9.3.1.6). |

It should be noted that the 3GPP specification uses different names for the cell Id. For example, 3GPP specifications may use the terms: NCGI, NR CGI, to denote the combination of PLMN identity and CellIdentity together; CellIdentity or NR Cell Identity is a 36 bit cell identification. The 3GPP specifications also define a much smaller identity for a cell called Physical cell identity or PCI. PCI may be coded as PhysCellId, and which is an integer between 0 and 1007.

If a sidelink (SL) remote UE as described herein is able to identify if a NR cell and a SL relay are terminating in (or belonging to) the same gNB, then the remote UE may use multi-path diversity. The NR cell identity (NCGI, NR CGI or CellIdentity) included currently in the 5G ProSe Direct Discovery Announcement message (as defined in Release 17 3GPP specification e.g., in TS 23.304 v 17.4.0) does not reveal the gNB Id and therefore it is not apparent how a UE would determine if a NR cell and a SL relay are terminating in the same gNB.

Being unable to determine whether a cell and a relay node terminate in the same Node B means that the Remote UE will miss out on relay UEs that are served by a different NR cell (from the remote UE's current serving cell) but still belonging to the same gNB (as that of the UE's serving cell's). In worst case, UE may not be able to enjoy multi-path diversity, which could lead to unsatisfactory user experience or inefficient network load management.

Being unable to determine whether a cell and a relay node terminate in the same Node B may also mean that the Remote UE will miss out on other NR cells belonging to the same gNB as the gNB of the serving cell of the connected sidelink relay UE. The UE may not be able to enjoy multi-path diversity, which could lead to unsatisfactory user experience or inefficient network load management.

FIG. 8 illustrates the NR Cell Global Identity (NCGI) 800. NCGI 800 comprises a Mobile Country Code (MCC) 810 having 3 bits, a Mobile Network Code (MNC) 820 having 2 or 3 bits, and a NR Cell Identity (NCI) 830, with NCI having a total size of 36 bits. These 36 bits constitute a gNB Identity (gNB ID) 832 and a Cell Identity (CI) 834. The NR Cell Identity 830 is broadcast within System Information Block 1 (SIB #1). The gNB ID 832 can be configured to use between 22 bits to 32 bits which leaves between 14 bits and 4 bits for the CI 834, respectively.

A PC5 communication channel is used to carry the discovery message over PC5 and the discovery message over PC5 is differentiated from other PC5 messages by AS layer.

Both Model A and Model B discovery are defined as in 3GPP TS 23.303 v 17.0.0.-Model A uses a single discovery protocol message, this may be termed ‘Announcement’. Model B uses two discovery protocol messages, this may be termed ‘Solicitation and Response’.

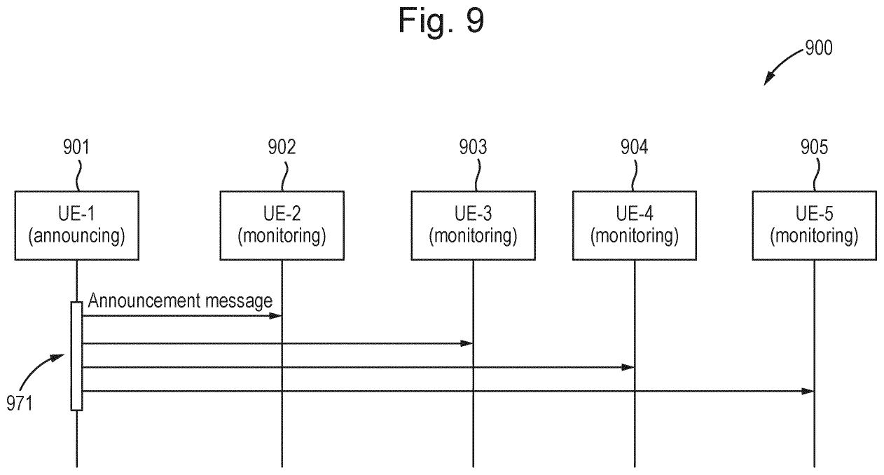

FIG. 9 illustrates a procedure 900 for 5G ProSe Direct Discovery with Model A, using a single discovery protocol message (‘Announcement’). FIG. 9 illustrates a system comprising a UE-1 901, and UE-2 902, a UE-3, 903, a UE-4 904, and a UE-5 905. In this arrangement the UE-1 901 is an announcing UE, and the UE-2 902, the UE-3, 903, the UE-4 904, and the UE-5 905 are monitoring UEs.

At 971, the Announcing UE 901 sends an Announcement message. The Announcement message may include the Type of Discovery Message, ProSe Application Code or ProSe Restricted Code, security protection element, and/or metadata information. Application layer metadata information may be included as metadata in the Announcement message. Each Monitoring UE 902 to 905 determines the Destination Layer-2 ID for signalling reception. The Destination Layer-2 ID is configured with the UE(s).

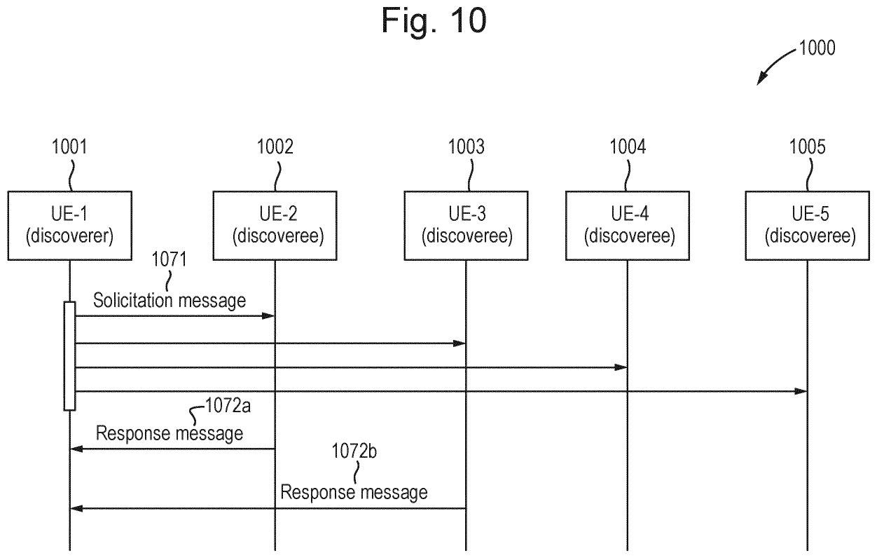

FIG. 10 illustrates a procedure 1000 for 5G ProSe Direct Discovery with Model B, using two discovery protocol messages (‘Solicitation and Response’). FIG. 10 illustrates a system comprising a UE-1 1001, and UE-2 1002, a UE-3 1003, a UE-4 1004, and a UE-5 1005. In this arrangement the UE-1 1001 is a discoverer, and the UE-2 1002, the UE-3 1003, the UE-4 1004, and the UE-5 1005 are discoverees.

At 1071, the Discoverer UE 1001 sends a Solicitation message. The Solicitation message may include Type of Discovery Message, ProSe Query Code, and/or a security protection element.

The Discoveree UE that matches the solicitation message, in this case UE-2 1002 and UE-3 1003, responds to the Discoverer UE 1001 with a Response message 1072a and 1072b. The Response message may include Type of Discovery Message, ProSe Response Code, security protection element, and/or metadata information. The Application layer metadata information may be included as metadata in the Response messages 1072a, 1072b.

Seven example implementations are described below.

Example #1 deals with Model A based Discovery described above. In this example, a 5G ProSe Direct Discovery Announcement message from a sidelink relay user equipment (SL relay) includes a LENGTH field alongside the 36-bit long NR Cell Identity. Remote UE determines gNB Id as the leftmost LENGTH bits of the received NR Cell Identity IE included in 5G ProSe Direct Discovery message from the SL relay. Further, the remote UE determines if the gNB Id (RAN node identity) received in and determined from the 5G ProSe Direct Discovery message is same as that included in the System Information Block 1 message of the serving cell (i.e., the cell with which the UE has established RRC connection). If there are many PLMN entries available in the SIB1, the UE uses the CellIdentity information and the gNB-ID-Length from the first entry in the PLMN list. When the SL relay UE's gNB Id is same as that of remote UE's, it goes ahead and attempts to establish PC5 RRC Connection either autonomously or first reports the sidelink Relay UE to the serving cell, optionally including radio measurement values (RSRP, RSRQ), and one or more parameters from the 5G ProSe UE-to-Network

Relay Discovery Announcement message:
Source Layer-2 ID
Destination Layer-2 ID
Discoveree/Discoverer Info
Target Info
Announcer Info
Relay Service Code.
NCGI of the serving cell of the 5G ProSe UE-to-Network Relay.
Tracking Area Identity of the serving cell of the 5G ProSe UE-to-Network Relay

In example #2, a 5G ProSe Direct Discovery Announcement and Solicitation message includes the gNB Id of the serving cell of the relay UE and/or remote UE. The gNB Id can be signalled to the relay and remote UE from its serving cell in a RRC message or a MAC CE upon request or unsolicited.

Example #3 deals with Model B based Discovery described above. In this example, a gNB Id field is included in the solicitation message-which is received in a dedicated RRC message or obtained from the SIB1 of the remote UE's serving cell: the remote UE receives SIB1 from its NR serving cell and determines the gNB Id of this serving cell as the leftmost LENGTH (called gNB-ID-Length and is included in PLMN-IdentityInfo of CellAccessRelatedInfo) bits of the received NR Cell Identity IE (cellIdentity included in PLMN-IdentityInfo of CellAccessRelatedInfo). Only those discoveree UE(s)-relay UEs-send a response message back to the discoverer UE-remote UE-whose serving cell belong to the same gNB, as the gNB Id received in the solicitation message. Relay UE determine their gNB Id in a way similar to remote UE i.e., from SIB1; or, the gNB Id can be signalled to the relay UE from the serving cell. If there are many PLMN entries available in the SIB1, the UE uses the CellIdentity information and the gNB-ID-Length from the first entry in the PLMN list. Alternatively, any PLMN Id in the list where the CellIdentity matches the one included in the Discovery (or Solicitation) message, is taken as the PLMN Id for comparison with a PLMN in the Discovery message.

In example #4, and in contrast to example #1, the LENGTH field is not included in the discovery message but rather the remote UE reports a sidelink Relay UE to the serving cell, including at least the NCGI of the serving cell of the 5G ProSe UE-to-Network Relay or the 36-bit long NR Cell Identity received in the Relay Discovery Announcement message and optionally one or more of radio measurement values (RSRP, RSRQ), and the following parameters:
Source Layer-2 ID;
Destination Layer-2 ID;
Discoveree/Discoverer Info;
Target Info;
Announcer Info;
Relay Service Code; and/or.
Tracking Area Identity of the serving cell of the 5G ProSe UE-to-Network Relay.

The serving cell determines, based on the received information, if the relay is being served by the same gNB as the gNB of the serving cell. When yes, the serving cell indicates the remote UE to establish PC5 RRC Connection with the said relay UE; otherwise, (when no) the remote UE needs to discover further such a relay UE.

In another implementation, the NG-RAN node may determine the gNB ID length of the candidate gNB based on e.g., OAM configuration. If the NG-RAN node is not able to make this determination, it may include the NR cell identifier in the UPLINK RAN CONFIGURATION TRANSFER message to the AMF to enable target identification by the AMF, when supported by the AMF. The AMF may, if supported, try to match the N leftmost bits of the NR cell identifier with an NG-RAN node ID it connects to, decreasing N starting with a value 32 and identify the target NG-RAN node ID as the first successful match. AMF informs the result to the NG-RAN node, which in turn indicates the remote UE to establish PC5 RRC Connection with the said relay UE, or not.

In example #5, a UE receives SIB1 from a NR serving cell and determines the gNB Id of this serving cell as the leftmost LENGTH (called gNB-ID-Length and is included in PLMN-IdentityInfo of CellAccessRelatedInfo) bits of the received NR Cell Identity IE (cellIdentity included in PLMN-IdentityInfo of CellAccessRelatedInfo). Further, the remote UE determines if this gNB Id is same as the gNB Id received in and determined from the 5G ProSe Direct Discovery message of a PC5 RRC Connected sidelink relay UE. When the SL relay UE's gNB Id is same as that of NR Cell's, it goes ahead and attempts to establish Uu RRC Connection with the same NR cell; otherwise, it looks for other NR cells.

In example #6, a sidelink relay UE includes NCGI in the Discovery message, which contains the PLMN Id as first 5 or 6 Digits, as shown in FIG. 8, which could be separately coded as PLMN Id If not, the remote UE extract the PLMN Id from the received NCGI as the most significant bits until the 36 least significant bits. Next, remote UE determines if the PLMN Id and the gNB Id combination of the relay UE's serving cell is same as that of PLMN Id and the gNB Id received in SIB1 of a NR Cell. The said gNB Id is determined as in the previous embodiments using the LENGTH field included in the Discovery Announcement or Solicitation message. The PLMN Id of the NR Cell used for the said determination can be one of the following:
The first PLMN Id in the list where the CellIdentity matches the one included in the Discovery (or Solicitation) message.
Any PLMN Id in the list where the CellIdentity matches the one included in the Discovery (or Solicitation) message

TABLE 3

```
PLMN-IdentityInfoList ::= SEQUENCE (SIZE (1..maxPLMN)) OF PLMN-
IdentityInfo
PLMN-IdentityInfo ::= SEQUENCE {
    plmn-IdentityList SEQUENCE (SIZE (1..maxPLMN)) OF PLMN-
Identity,
    trackingAreaCode TrackingAreaCode OPTIONAL, --
Need R
    ranac RAN-AreaCode OPTIONAL, --
Need R
    cellIdentity CellIdentity,
    cellReservedForOperatorUse ENUMERATED {reserved, notReserved},
    ...,
    [ [
    iab-Support-r16 ENUMERATED {true} OPTIONAL --
Need S
    ] ],
    [ [
    trackingAreaList-r17 SEQUENCE (SIZE (1..maxTAC-r17) ) OF TrackingAreaCode
OPTIONAL, -- Need R
    gNB-ID-Length-r17 INTEGER (22..32) OPTIONAL -- Need R
    ] ]
}
```

In case of Model B based discovery, the relay UE (Discoveree) will extract PLMN Id and gNB Id from the remote UE (Discoverer) Discovery Solicitation message and compare with the PLMN Id and gNB Id of its serving cell, both determined as described previously i.e., from the SIB1. An example of PLMN information included in SIB1 is shown in table 3, above.

In example #7, a “cell-id-LENGTH” is signalled in the Discovery message (Announcement and/or Solicitation) alongside the NCGI. The receiver UE compares the bitstring of NCGI truncating off (or ignoring) the last or rightmost (least significant) cell-id-LENGTH bits. The UE determines the PLMN Id and gNB Id of its serving cell, both determined as described previously i.e., from the SIB1.

It should be noted that when referring to “leftmost LENGTH bits” previously, it could be also the rightmost LENGTH bits, or even a set of bits present inside the 36-bit long cell identity, in which case an offset from either end of the 36-bit BITSTRING is also provided to the UE along with the LENGTH field.

Accordingly, there is provided a LENGTH field indicating the length of a gNB identity in 36-bit long NR Cell Identity, and this is included in a Discovery message sent by a sidelink UE (either a relay UE or a remote UE).

The Remote UE determines if this gNB Id is same as the gNB Id received in and determined from the 5G ProSe Direct Discovery message and that of SIB1. How and which PLMN Id and gNB-ID-Length is determined from the serving cell's SIB1. The remote UE may perform a comparison of gNB Id and PLMN Id among the information received from SIB1 and Discovery message. “cell-id-LENGTH” is signalled in the Discovery message (Announcement and/or Solicitation) alongside the NCGI, then the UE compares all significant “cell-id-LENGTH” bits not including the least significant bits.

A sidelink remote UE needs to identify if a NR cell and a SL relay are terminating in (or belonging to) the same gNB to be able to use multi-path diversity. The NR cell identity (NCGI, NR CGI) included currently (in Rel. 17 3gpp specification e.g., in TS 23.304 v17.4.0) in the 5G ProSe Direct Discovery Announcement message does not reveal the gNB Id and therefore it is not easy for a UE to determine if a NR cell and a SL relay are terminating in the same gNB. Therefore, following two problems might arise:
Remote UE will miss out on relay UEs that are served by a different NR cell (from the remote UE's current serving cell) but still belonging to the same gNB (as that of the UE's serving cell's). In worst case, UE may not be able to enjoy multi-path diversity, which could lead to unsatisfactory user experience or inefficient network load management.
Remote UE will miss out on other NR cells belonging to the same gNB as the gNB of the serving cell of the connected sidelink relay UE. In worst case, UE may not be able to enjoy multi-path diversity, which could lead to unsatisfactory user experience or inefficient network load management.

There is described herein an embodiment that enables the relay UE to broadcast the length of the serving gNB Id in the Discovery message. A remote UE uses this information to extract the gNB Id from the received NR cell identity included in the relay's discovery message.

It is possible that the 36 bits long NR Cell Identity/CellIdentity is used to make the above determination and by doing that it will only consider:
Sidelink relay UEs that are served by the same NR cell as the UE's serving cell. By doing this, remote UE will miss out on relay UEs that are served by a different NR cell (from the UE's serving cell) belonging to the same gNB (as that of the UE's serving cell's). In worst case, UE may not be able to enjoy multi-path diversity, which could lead to unsatisfactory user experience or inefficient network load management.
NR cell that is the serving cell of the connected sidelink relay UE. By doing this, remote UE will miss out on other NR cells belonging to the same gNB as the gNB of the serving cell of the connected sidelink relay UE. In worst case, UE may not be able to enjoy multi-path diversity, which could lead to unsatisfactory user experience or inefficient network load management.

In one embodiment, a 5G ProSe Direct Discovery message from a sidelink relay user equipment (SL relay) includes a LENGTH field alongside the 36-bit long NR Cell Identity. The Remote UE determines gNB Id as the leftmost LENGTH bits of the received NR Cell Identity IE included in 5G ProSe Direct Discovery message from the SL relay. Further, the remote UE determines if the gNB Id (RAN node identity) received in and determined from the 5G ProSe Direct Discovery message is same as that included in the System Information Block 1 message of the serving cell (i.e., the cell with which the UE has established RRC connection). When the SL relay UE's gNB Id is same as that of remote UE's, it goes ahead and attempts to establish PC5 RRC Connection.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field of the present document: BS, Base Station; DL, Downlink; gNB, RAN Node in 5G NR; L3, Layer 3 (RRC); LTE, Long Term Evolution; MAC, Medium Access Control; NCGI, NR Cell Global Identity (NCGI=PLMN Id+36-bit long NCI); NR, New Radio; PCI, Physical Cell Identity (PCI is an INTEGER (0 . . . 1007)); Phy, Physical Layer (also known as layer-1, L1); PRACH, Physical Random Access Channel; RACH, Random Access Channel; RAN, Radio Access Network, e.g., eNB or gNB; RAT, Radio Access Technology; RRC, Radio Resource Control; RSRP, Reference signal receive Power; RSRQ, Reference signal receive Quality; RSRP, Reference Signal Received Power; SI, Study Item; SIB, System Information Block; UE, User Equipment; UL, Uplink; and WI, Work Item.

1. A method in a first user equipment (UE), the method comprising:
receiving a discovery message that includes a cell identity and a length field from a second UE;
receiving a system information message from a serving cell of a serving node;
determining a node identity from the discovery message; and
determining if the node identity from the discovery message is a same identity as a node identity included in the system information message.

2. The method of claim 1, wherein receiving the discovery message comprises receiving the discovery message before receiving the system information message.

3. The method of claim 1, wherein receiving the system information message comprises receiving the system information message before receiving the discovery message.

4. The method of claim 1, further comprising selecting the second UE to provide indirect connectivity towards the serving node if the node identity from the discovery message is the same identity as the node identity included in the system information message.

5. The method of claim 1, further comprising searching for a third UE to provide indirect connectivity towards the serving node if the node identity from the discovery message is not the same identity as the node identity included in the system information message.

6. The method of claim 5, wherein the searching for a third UE comprises performing a discovery procedure.

7. The method of claim 1, wherein the first UE has a radio resource control (RRC) connection with the serving node.

8. The method of claim 1, wherein the node identity from the discovery message is included inside a 36 bits long cell identity and is determined as a leftmost length bits of a cell identity information element (IE) included in the discovery message.

9. A first user equipment (UE) for wireless communication, comprising:
at least one memory; and
at least one processor coupled with the at least one memory and arranged to cause the first UE to:
receive a discovery message that includes a cell identity and a length field from a second UE;
receive a system information message from a serving cell of a serving node;
determine a node identity from the discovery message;
determine if the node identity from the discovery message is a same identity as a node identity included in the system information message.

10. The first UE of claim 9, wherein the at least one processor is further arranged to cause the first UE to receive the discovery message before the system information message.

11. The first UE of claim 9, wherein the at least one processor is further arranged to cause the first UE to receive the system information message before the discovery message.

12. The first UE of claim 9, wherein the at least one processor is further arranged to cause the UE to select the second UE to provide indirect connectivity towards the serving node if the node identity from the discovery message is the same identity as the node identity included in the system information message.

13. The first UE of any of claim 9, wherein the at least one processor is further arranged to cause the first UE to search for a third UE to provide indirect connectivity towards the serving node if the node identity from the discovery message is not the same identity as the node identity included in the system information message.

14. The first UE of claim 13, wherein to search for a third UE, the at least one processor is further arranged to cause the first UE to perform a discovery procedure.

15. The first UE of claim 9, wherein the first UE has a radio resource control (RRC) connection with the serving node.

16. The first UE of claim 9, wherein the node identity is included inside a 36 bits long cell identity and is determined as a leftmost length bits of a cell identity information element (IE) included in the discovery message.

17. (canceled)

18. (canceled)

19. A base station for wireless communication, comprising:
at least one memory; and
at least one processor coupled with the at least one memory and arranged to cause the base station to:
transmit a system information message;
receive a radio resource control (RRC) setup request;
transmit an RRC setup complete.

20. The base station of claim 19, wherein the system information message includes an identity of the base station.

21. A method performed by a base station, the method comprising:
transmitting a system information message;
receiving a radio resource control (RRC) setup request; and
transmitting an RRC setup complete.

22. The method of claim 21, wherein the system information message includes an identity of the base station.
